(19) United States
(12) Patent Application Publication
(10) Pub. No.: US 2005/0013112 A1
(43) Pub. Date: Jan. 20, 2005

(54) Industry computer structure with two expansive forms

(76) Inventor: Chein Ming Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/892,110

(22) Filed: Jul. 16, 2004

(30) Foreign Application Priority Data
Jul. 18, 2003 (TW) 92213226

(51) Int. Cl. G06F 1/16

(52) U.S. Cl. 361/686

(57) ABSTRACT

An industry computer structure includes a seat (1) and a cover (2) attached to each other to form a receiving space (A). A side cover (5) is attached to the seat (1) and the cover (2) to close the receiving space (A). A main board (31) is secured on the seat (1). A second socket (34) is mounted on the main board (31) and provided for multiple first expansion cards (4A) separately piled one after one under a standard of PC104/104-plus. A connector (35) is mounted to the first side of the main board (31) and a bridge card (36) is partially inserted into the connector (35). The bridge card (36) includes multiple expansion connectors (361) sequentially mounted thereto and provided for multiple second expansion cards (4B) being mounted on the bridge card (36) under a standard of PCI/ISA.

### FIELD OF THE INVENTION

The present invention relates to an industry computer structure, and more particularly to an industry computer structure with two expansive forms for easily disassembling and wiring.

### DESCRIPTION OF RELATED ART

The conventional industry computer structures in accordance with the prior art are classified into two forms, such as insert-form and pile-form.

In the insert-form, multiple connectors are disposed on a horizontal printed circuit board for partially receiving an expansion card after the expansion card inserted into a corresponding one of the connector. The insert-form is usually used under a standard of peripheral component interconnect (PCI)/industry standard architecture (ISA) or compact PCI.

The number of the expansion card is limited by that of the connector in insert-form because each connector only connects to a corresponding one of the expansion cards and the each expansion card is perpendicular relative to the printed circuit board, that is, the number of the expansion cards is relative to an area of the printed circuit board.

In the pile-form, there is at least one connector secured on a printed circuit board for an expansion card being partially inserted in a corresponding one of the connectors under a standard of PC104/PC104-plus. The expansion card is parallel to the printed circuit board. The expansion card has a connector secured thereon such that the expansion cards can be piled one after one and parallel to one another. Consequently, the number of the expansion cards does not be limited by the area of the printed circuit board.

The assemble and disassemble methods of the above two forms are different to each other such that the two forms cannot be used in a industry computer structure. The user needs to prepare two industry computer structures when the two forms are necessary to be used at the same time. It is inconvenient to the user.

The main objective of the present invention is to provide an improved industry computer structure that has two expansive forms.

To achieve the objective, the industry computer structure in accordance with the present invention comprises a seat and a cover attached to each other to form a receiving space with five closed sides. A side cover is laterally attached to the seat and the cover to close the receiving space. A main board is secured on the seat. A second socket is electrically mounted on the main board and provided for multiple first expansion cards separately piled one after one under a standard of PC104/104-plus. A connector is electrically mounted to the first side of the main board and a bridge card is partially inserted into the connector. The bridge card includes multiple expansion connectors sequentially horizontally mounted thereto and provided for multiple second expansion cards being mounted on the bridge card under a standard of PCI/ISA.

### IN THE DRAWINGS

FIG. 1 is a perspective view of an industry computer structure with two expansive forms in accordance with the present invention;

FIG. 2 is an exploded perspective view of the industry computer structure in FIG. 1;

FIG. 3 is a cross-sectional view of the industry computer structure in FIG. 1 along line 3-3;

FIG. 4 is a cross-sectional view of the industry computer structure in FIG. 1 along line 4-4;

FIG. 5 is a first operational plan view of the industry computer structure of the present invention; and

FIG. 6 is a second operational plan view of the industry computer structure of the present invention.

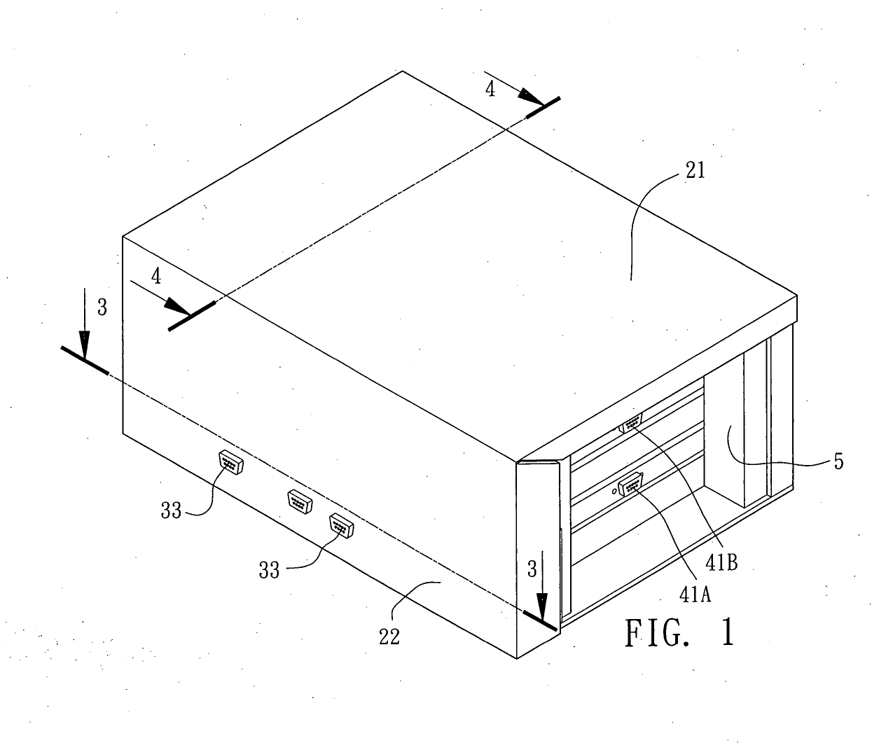

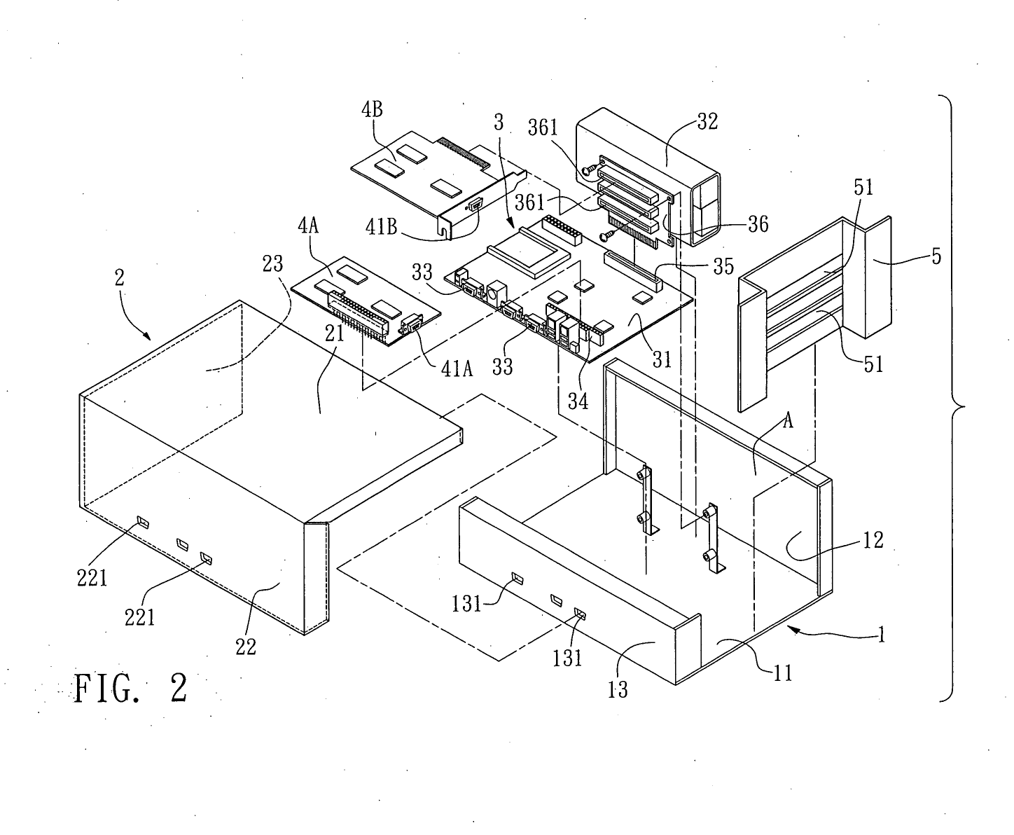

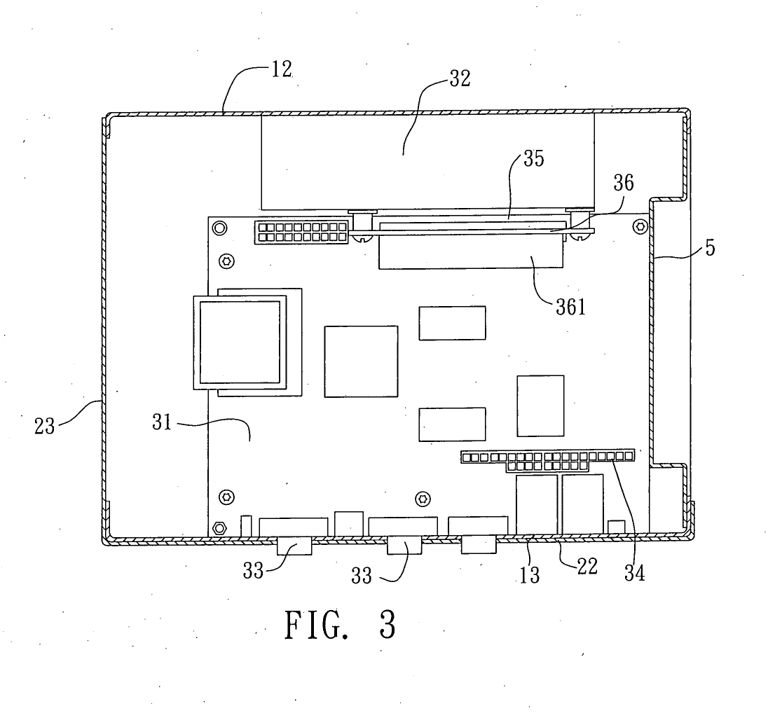

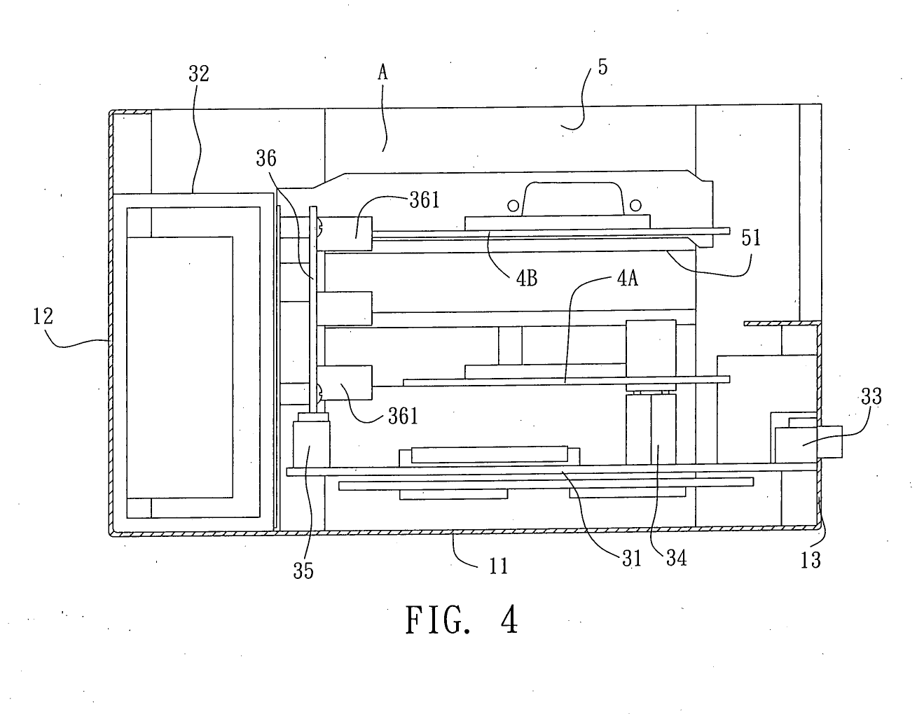

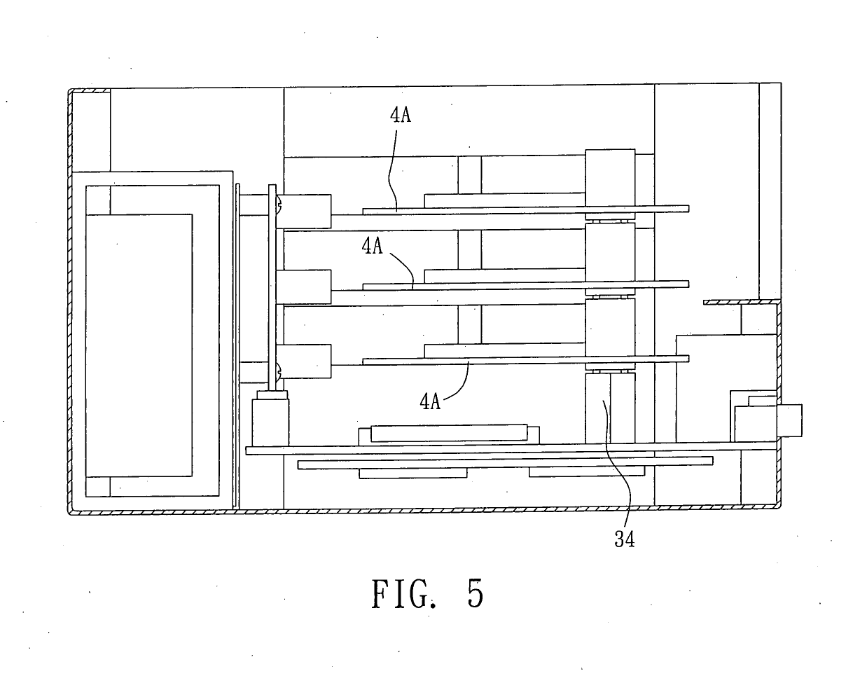

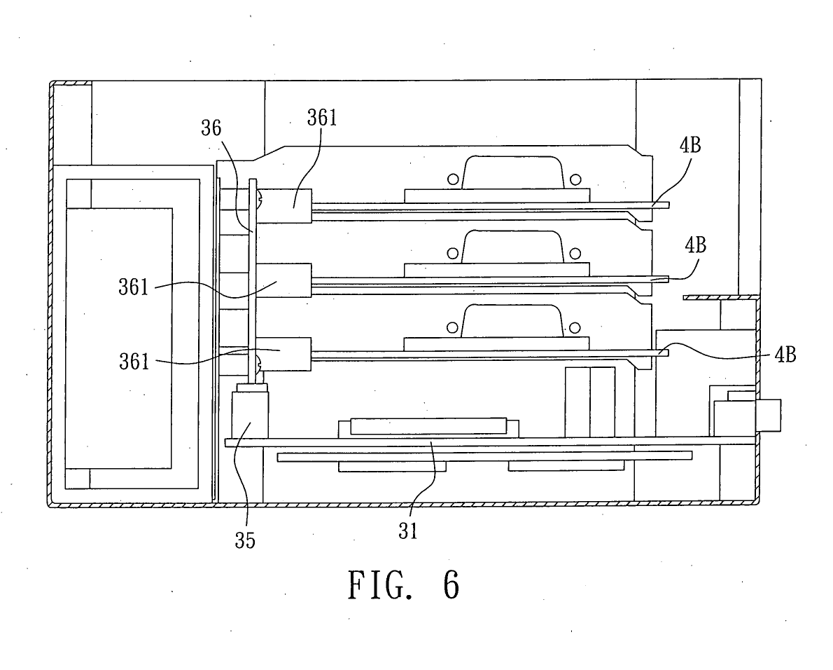

Referring to the drawings and initially to FIGS. 1-6, an industry computer structure with two expansive forms in accordance with the present invention comprises seat (1), a cover (2) attached to the seat (1), a side cover (5) laterally attached to the seat (1) and the cover (2) and a circuit board assembly (3) secured on the seat (1) within the seat (1), the cover (2) and the side cover (5).

The seat (1) includes a base plate (11) having a first side and a second side opposite to the first side of the base plate (11). The first side of the base plate (11) has a front sheet (12) perpendicularly extending from the base plate (11) and the second side of the base plate (11) has a rear sheet (13) perpendicularly extending from the base plate (11). The rear sheet (13) has multiple through holes (131) defined therein.

The cover (2) includes a top sheet (21) and a rear sheet (22) being perpendicular relative to each other. The top sheet (21) has a free end attached to a free end of the front sheet (12) of the seat (1) and the rear sheet (22) of the cover (2) laterally abuts the rear sheet (13) of the seat (1) to form a receiving space (A) between the seat (1) and the cover (2). The rear sheet (22) of the cover (2) has multiple through holes (221) defined therein and each aligning and communicating with a corresponding one of the multiple through hole (131) in the rear sheet (13) of the seat (1). The cover (2) includes a side sheet (23) integrally extending from the top sheet and the rear sheet (22) for closing a first end of the receiving space (A).

The side cover (5) is attached to one side of the seat (1) and cover (2) for closing a second end of the receiving space (A). The side cover (5) has multiple slots (51) sequentially horizontally defined therein.

The circuit board assembly (3) is received in the receiving space (A) and secured on the base plate (11) of the seat (1). The circuit board assembly (3) includes a main board (31) secured on the base plate (11) of the seat (1). A power supplier (32) is mounted on a first side of the main board (31) and multiple first sockets (33) are electrically mounted on a second side of the main board (31). Each first socket (33) extends through a corresponding one of the multiple through holes (221) in the rear sheet (22) of the cover (2) and adapted to be electrically connected to a PC equipment. A second socket (34) is electrically mounted on the main board (31) near the second side of the main board (31). The second socket (34) is provided for multiple first expansion cards (4A) being separately piled one after one under the standard of PC104/104-plus. Each first expansion card (4A) is parallel to the main board (31) and having a connecting side extending through a corresponding one of the multiple slots (51) in the side cover (5). A first expansion socket (41A) is electrically mounted on the connecting side of the first expansion card (4A) after extending through the side cover (5). A connector (35) is electrically mounted to the first side of the main board (32) and a bridge card (36) is partially inserted into the connector (35). The bridge card (36) is perpendicular relative to the main board (31). The bridge card (36) has multiple expansion connectors (361) sequentially horizontally mounted to the bridge card (36). The multiple expansion connectors (361) are provided for multiple second expansion cards (4B) being mounted under the standard of PCI/ISA. Each second expansion card (4B) has a second expansion socket (41B) extending through a corresponding one of the multiple slots (51) in the side cover (5) for connected to a PC equipment.

The second socket (34) of the present invention is provided for the first expansion cards (4A) arranged in a form of PC104/104-plus, and the connector (35) and the bridge card (36) are provided for the second expansion cards (4B) arrange in a form of PCI/ISA. Consequently, the industry computer structure in accordance with the present invention can be used in two expansive forms of the PCI/ISA and the PC104/104-plus. The first expansion cards (4A) and the second expansion cards (4B) can be received in the receiving space at the same time and do not cause a conflict between the first expansion cards (4A) and the second expansion cards (4B). As described above, the industry computer structure of the present invention can greatly broaden the using scope of expansion cards.

1. An industry computer structure with two expansive forms, comprising:
a seat and a cover attached to each other to form a receiving space with five closed sides;
a side cover laterally attached to the seat and the cover to close the receiving space; and
a circuit board assembly secured on the seat and including:
a main board secured on the seat;
a power supplier mounted on a first side of the main board;
multiple first sockets electrically mounted on a second side of the main board, each first socket extending through the cover and adapted to be electrically connected to a PC equipment;
a second socket electrically mounted on the main board near the second side of the main board, the second socket being provided for multiple first expansion cards separately piled one after one, each first expansion card including a connecting side extending through the side cover and having a first expansion socket electrically mounted thereon; and
a connector electrically mounted to the first side of the main board and a bridge card is partially inserted into the connector, the bridge card including multiple expansion connectors sequentially horizontally mounted thereto, the multiple expansion connector being provided for multiple second expansion cards being mounted on the bridge card.

2. The industry computer structure as claimed in claim 1, wherein the multiple first expansion cards are separately piled under a standard of PC104/104-plus.

3. The industry computer structure as claimed in claim 1, wherein the multiple second expansion cards are mounted on the bridge card under a standard of PCI/ISA.
